(19) United States
(12) Patent Application Publication
(10) Pub. No.: US 2011/0216409 A1
(43) Pub. Date: Sep. 8, 2011

(54) OPTICAL BARRIER DEVICE

(76) Inventor: RICHARD Dale STUTES, Temple, TX (US)

(21) Appl. No.: 12/717,131

(22) Filed: Mar. 4, 2010

(51) Int. Cl. G02B 27/00

(52) U.S. Cl. 359/507

(57) ABSTRACT

The present invention relates to a protective barrier device for covering an intraoral camera comprising: a flexible plastic body, said body having an opening for inserting the intraoral camera; and a hard clear plastic window at the distal end of the plastic body. The flexible plastic body is of sufficient length to cover the entire length of an appendage of the intraoral camera. The window aligns with a camera lens of the intraoral camera when the plastic body is placed over the appendage and may be constructed of a fog-resistant plastic.

### BACKGROUND OF THE INVENTION

1. Field of Invention

The present invention relates to an optical barrier device used to protect a patient from the transfer of germs or bacteria that may occur through the use of dental instruments.

2. Description of Related Art

It is imperative for dental instruments to remain free of bacteria and germs that can cause cross-contamination between and among patients. Dental instruments may be used on several patients over a given period of time. Many dental instruments require sterilization immediately after use while others may be disposed of after a single use. In addition to sterilization and disposal, another technique to maintain bacteria free instruments includes the use of covering or draping of instruments during the use. U.S. Pat. No. 4,723,912 discloses a draping apparatus for covering dental and medical equipment and appendages extending therefrom such as water hoses, electrical cords and the like. U.S. Pat No. 5,217,370 discloses a single use disposal infection control barrier for use with dental appliances that includes elongated bag with a first open end and a second closed end so that the last portion of the dental instrument may be inserted through the opening in the bag to the second end of the bag. The control barrier according to the '370 patent is transparent so that the user may observe the dental appliance through the bag and flexible to permit the user to operate the dental appliance through the bag.

Many dental offices and facilities use intraoral cameras to provide a means to photograph and video the patient's teeth, gums and mouth. In some dental offices, a single camera may be used in each examination room; other dental offices may use a single camera for multiple examination rooms. These devices are especially conducive for the use of a covering in order to prevent the spread of infection and to ensure that the bacteria or germs are spread between patients. One drawback to using covering on an intraoral cameral is that the camera produces a significant amount of heat and moisture. Therefore use of a plastic covering can fog the camera lens and therefore inhibit the view available from the camera while the plastic covering is in place. Consequently, it would be advantageous to have a plastic covering that can effectively provide a infection control barrier but yet does not cause fogging of the camera lens and the barrier making the photography available through the camera less effective.

### SUMMARY OF THE INVENTION

The present invention relates to a protective barrier device for covering an intraoral camera comprising: a flexible plastic body, said body having an opening for inserting the intraoral camera; and a hard clear plastic window at the distal end of the plastic body. The flexible plastic body is of sufficient length to cover the entire length of an appendage of the intraoral camera. The window aligns with a camera lens of the intraoral camera when the plastic body is placed over the appendage and may be constructed of a fog-resistant plastic.

### BRIEF DESCRIPTION OF DRAWINGS

FIG. 1 depicts a view of a protective barrier device in accordance with the present invention.

FIG. 2 shows application of the barrier device in conjunction with the intraoral camera.

FIG. 3 depicts the underside or lens side of the intraoral camera.

FIG. 4 depicts placement of the barrier device over the intraoral camera lens area.

### DETAILED DESCRIPTION

The present invention provides a means to prevent and eliminate contamination of intraoral cameras during use in a dental office. Infection control is a primary concern of every dental office and with the wide use of intraoral cameras, the present invention provides a solution consisting of a protective barrier that covers the intraoral camera and therefore helps to maintain the camera in a sterilized and infection free state. The optical protective barrier according to present invention essentially is a plastic covering with inclusion of a hard plastic clear lens anchored within the plastic covering. The hard plastic clear lens is positioned over the lens of the intraoral camera and therefore helps to eliminate the fogging and other drawbacks related to the use of a conventional plastic covering over an intraoral camera.

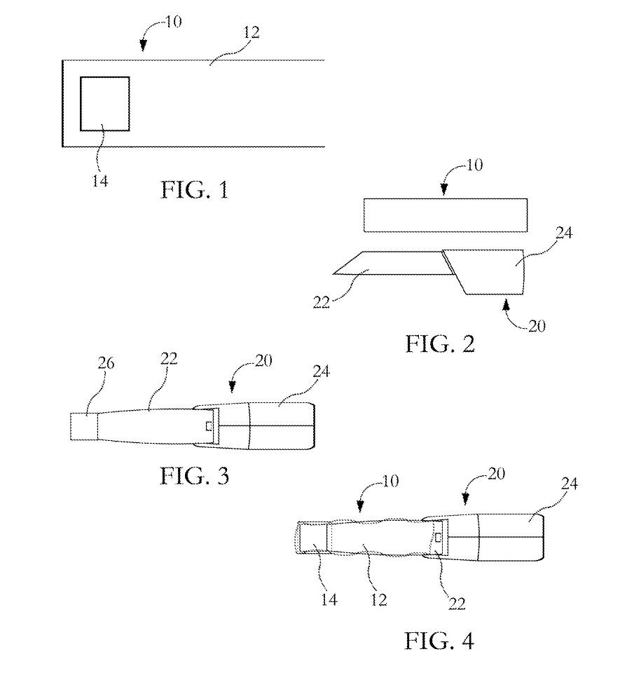

An exemplary Optical Barrier Device 10 is depicted in FIG. 1. The Barrier Device 10 includes a flexible plastic body that has a hard plastic clear window position that the distal end there of. The plastic Body 12 is shown in FIG. 1 with a hard plastic Lens 14. The use of this Barrier Device 10 according to the present invention helps to eliminate the problems of fog that are created due to the heat and moisture when a covering is used on an intraoral camera. In one particular embodiment of the present invention, the Protective Barrier 10 is a form-fitting plastic bag that has dimensions of 1.9 inches by 5 inches in length. At one end thereof the plastic Window 14 with the dimensions of 22 millimeters by 22 millimeter square is provided.

In FIG. 2, the Barrier Device 10 is shown adjacent to an Intraoral Camera 20. As noted the intraoral camera has a Handle 24 and an extended Appendage 22. The Appendage 22 is placed in the patient's mouth in order to capture the images through the lens of the Intraoral Camera 20. As noted the Barrier Device 10 is of sufficient length to cover the entire length of the Appendage 22 which is placed within the patient's mouth. FIG. 3 depicts the underside or lens side of the intraoral camera where a clear view is shown of a camera Lens 26 at the distal end of the Appendage 22. Opposite the camera Lens 26 is the Handle 24 of the Intraoral Camera 20.

The Protective Barrier 10 slides over the Appendage 22 and protects the entire length of the Appendage 22 and Camera Lens 26. FIG. 4 depicts the placement of the Protective Barrier 10 over the Intraoral Camera 20. As depicted, the clear plastic Window 14 aligns with the Camera Lens 26 and the length of the Protective Barrier's Body 12 covers the Appendage 22. Use of the Barrier Device 10 provides an infection control mechanism that helps to ensure that the intraoral camera remains sterile and bacteria free. The use of the Protective Barrier 10 addresses any heat or moisture issues that may be generated by if a conventional clear plastic covering is used on the intraoral camera and therefore prevents fogging. The hard plastic window of the Protective Barrier 10 is constructed of a fog-resistant plastic and aligns itself with the camera lens when used with the intraoral camera. Although depicted in a manner of using a square plastic window, the Barrier Device 10 may be modified to conform to other intraoral cameras known in the prior art. The instant invention has been shown and described in what it considers to be the most practical and preferred embodiments. It is recognized, however, that departures may be made there from within the scope of the invention and that obvious modifications will occur to a person skilled in the art.

1. A protective barrier device for covering an intraoral camera comprising:
a. a flexible plastic body, said body having an opening for inserting the intraoral camera and where the flexible plastic body is form fitted to fit around an appendage of the intraoral camera and the body is 5 inches in length and 1.9 inches in width, and said window is 22 mm square; and
b. a hard clear plastic window at the distal end of the plastic body, where the hard clear plastic window aligns with a camera lens of the intraoral camera when the plastic body is placed over the appendage.

2. The protective barrier device according to claim 1, where the flexible plastic body is of sufficient length to cover the entire length of an the appendage of the intraoral camera.

3. (canceled)

4. (canceled)

5. The protective barrier device according to claim 1, where the plastic window is constructed of a fog-resistant plastic.
